(19) United States
(12) Patent Application Publication
(10) Pub. No.: US 2022/0343113 A1
(43) Pub. Date: Oct. 27, 2022

(54) AUTOMATIC MODEL RECONSTRUCTION METHOD AND AUTOMATIC MODEL RECONSTRUCTION SYSTEM FOR COMPONENT RECOGNITION MODEL

(71) Applicant: PEGATRON CORPORATION, TAIPEI CITY (TW)

(72) Inventors: Ting-An Jiang, TAIPEI CITY (TW); Kai-Chun Chang, TAIPEI CITY (TW)

(73) Assignee: PEGATRON CORPORATION, TAIPEI CITY (TW)

(21) Appl. No.: 17/694,333

(22) Filed: Mar. 14, 2022

(30) Foreign Application Priority Data
Apr. 27, 2021 (TW) 110115099

(51) Int. Cl. G06K 9/62; G06T 7/70; G06T 7/00

(52) U.S. Cl. CPC G06K 9/6257; G06T 7/70; G06K 9/6277; G06K 9/628; G06T 7/0004; G06T 2207/20081; G06T 2207/30141

(57) ABSTRACT

An automatic model reconstruction method and an automatic model reconstruction system for a component recognition model are provided. The automatic model reconstruction method includes the following steps. A first component image of a plurality of circuit boards is sequentially captured at a first position. The component recognition model sequentially recognizes component categories of the first component images, and a number of recognition probability values are output. According to the recognition probability values, a number of exponentially weighted moving averages (EWMA) are obtained. The first component images corresponding to the exponentially weighted moving averages lower than a first set value are collected until one of the exponentially weighted moving averages is lower than or equal to a second set value. The collected first component images are regarded as abnormal component images. The component recognition model is reconstructed according to the abnormal component images.

### CROSS-REFERENCE TO RELATED APPLICATION

This application claims the priority benefit of Taiwan application serial no. 110115099, filed on Apr. 27, 2021. The entirety of the above-mentioned patent application is hereby incorporated by reference herein and made a part of this specification.

### BACKGROUND

### Technology Field

The disclosure relates to an automatic model reconstruction method and an automatic model reconstruction system for a component recognition model, and in particular, to an automatic model reconstruction method and an automatic model reconstruction system adapted for a component recognition model of a circuit board.

### Description of Related Art

In an assembly line of circuit boards, component recognition models are usually used to detect whether correct components are disposed at each preset position on a circuit board. After the component recognition model is put on the assembly line, if missed detections or false alarms constantly occur, conventionally the component recognition model is required to be manually analyzed and adjusted before being put back on the assembly line.

In the current practice, the collection of abnormal data is not initiated until abnormal conditions of the component recognition model constantly occur, resulting in the suspension of the assembly line. After analyzing the reasons for the abnormal data, the component recognition model is adjusted, data is collected again, and the component recognition model is reconstructed so that the updated component recognition model is introduced. However, in the process of analysis and model reconstruction, the shutdown of the assembly line may increase the loss of the factory, so a method and a system that can automatically retrain the recognition model are required.

### SUMMARY

This disclosure relates to an automatic model reconstruction method and an automatic model reconstruction system for a component recognition model, which monitor the recognition probability value and the position where the component appears and automatically analyze training samples to automatically reconstruct the component recognition model.

According to an embodiment of the disclosure, an automatic model reconstruction method for a component recognition model is provided. The automatic model reconstruction method includes steps as follows. A plurality of first component images of multiple circuit boards are sequentially captured at a first position. Component categories of the first component images are sequentially recognized by the component recognition model, and multiple recognition probability values are output. Multiple exponentially weighted moving averages are obtained according to the recognition probability values. The first component images corresponding to the exponentially weighted moving averages lower than a first set value are collected until one of the exponentially weighted moving averages is lower than or equal to a second set value. The collected first component images are regarded as multiple abnormal component images, and the component recognition model is reconstructed according to the abnormal component images.

According to another embodiment of the disclosure, an automatic model reconstruction system for a component recognition model is provided. The automatic model reconstruction system includes an image capturing unit, a component recognition model, a model monitoring unit, and an automatic reconstruction unit. The image capturing unit is used for sequentially capturing a plurality of first component images of multiple circuit boards at a first position. The component recognition model is coupled to the image capturing unit. The component recognition model is used to sequentially recognize component categories of the first component images and output multiple recognition probability values. The model monitoring unit is coupled to the component recognition model. The model monitoring unit is used to obtain multiple exponentially weighted moving averages according to the recognition probability values and to determine a relationship between the exponentially weighted moving averages and a first set value and a relationship between the exponentially weighted moving averages and a second set value. The automatic reconstruction unit is coupled to the component recognition model and the model monitoring unit. The automatic reconstruction unit is used to collect the first component images corresponding to the exponentially weighted moving averages lower than the first set value until one of the exponentially weighted moving averages is lower than or equal to the second set value, the collected first component images are regarded as multiple abnormal component images, and the component recognition model is reconstructed according to the abnormal component images.

In order to make the above and other aspects of the disclosure comprehensible, embodiments accompanied with drawings are described in detail below.

### BRIEF DESCRIPTION OF THE DRAWINGS

FIG. 1 is a schematic view of a component recognition model according to an embodiment of the disclosure.

FIG. 2 is a block diagram of an automatic model reconstruction system of a component recognition model according to an embodiment of the disclosure.

FIG. 3A to FIG. 3B are flowcharts illustrating an automatic model reconstruction method of a component recognition model according to an embodiment of the disclosure.

FIG. 4 is a schematic view of a circuit board according to an embodiment of the disclosure.

FIG. 5 illustrates a distribution of an exponentially weighted moving average according to an embodiment of the disclosure.

FIG. 6A to FIG. 6C are flowcharts illustrating an automatic model reconstruction method of a component recognition model according to another embodiment of the disclosure.

### DESCRIPTION OF THE EMBODIMENTS

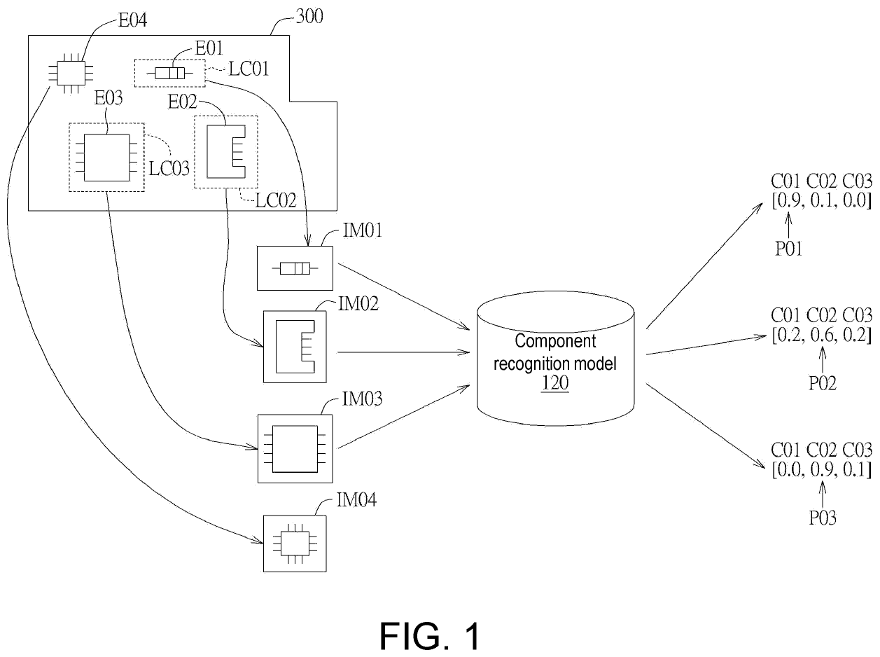

Referring to FIG. 1, FIG. 1 is a schematic view of a component recognition model 120 according to an embodiment of the disclosure. On a circuit board 300 of FIG. 1, components E01, E02, and E03 are planned to be disposed at positions LC01, LC02, and LC03, respectively. After a component image IM01 is captured at the position LC01, the component image IM01 may be input to the component recognition model 120 to recognize the component category, and a recognition probability value P01 is obtained. The recognition probability value P01 is the maximum probability value in the component categories C01, C02, and C03 (the maximum one of 0.9, 0.1, and 0.0 is 0.9). The component categories C01, C02, and C03 correspond to the components E01, E02, and E03, respectively. If the recognition probability value P01 output by the component recognition model 120 is greater than a preset threshold (e.g., 0.58) and corresponds to the component category C01, it means that the component E01 is correctly disposed at the position LC01. Generally, the recognition probability value P01 is much greater than the preset threshold.

After a component image IM02 is captured at the position LC02, the component image IM02 may be input to the component recognition model 120 to recognize the component category, and a recognition probability value P02 (i.e., 0.6) is obtained. If the recognition probability value P02 output by the component recognition model 120 is greater than the preset threshold and corresponds to the component category C02, it means that the component E02 is correctly disposed at the position LC02. However, in an actual assembly line, the ambient light may be too dim, resulting in the recognition probability value P02 being close to the preset threshold (e.g., 0.58). This situation indicates that the training data of the component recognition model 120 is insufficient to reflect the actual situation on the assembly line, and a model reconstruction is required to update the component recognition model 120.

Alternatively, after a component image IM03 is captured at the position LC03, the component image IM03 may be input to the component recognition model 120, and a recognition probability value P03 is obtained. If the recognition probability value P03 (i.e. 0.9) output by the component recognition model 120 is greater than the preset threshold and corresponds to the component category C02, it is recognized that the component E02 is incorrectly disposed at the position LC03. However, after a re-determining process, it can be found that the component E03 is indeed correctly disposed at the position LC03, and it means that the training data of the component recognition model 120 may no longer reflect the actual situation on the assembly line, and a model reconstruction is required to update the component recognition model 120.

Moreover, if a component image IM04 of a component E04 is newly found and not disposed at the preset positions LC01, LC02, and LC03 (especially when the component E04 is found on multiple circuit boards 300), it means the component E04 is required to be disposed, and a model reconstruction is required to update the component recognition model 120.

The aforementioned situations are situations where the component recognition model 120 requires to perform an automatic model reconstruction. In the embodiment, the required training samples may be automatically obtained regarding the situations, and the model reconstruction can be automatically performed.

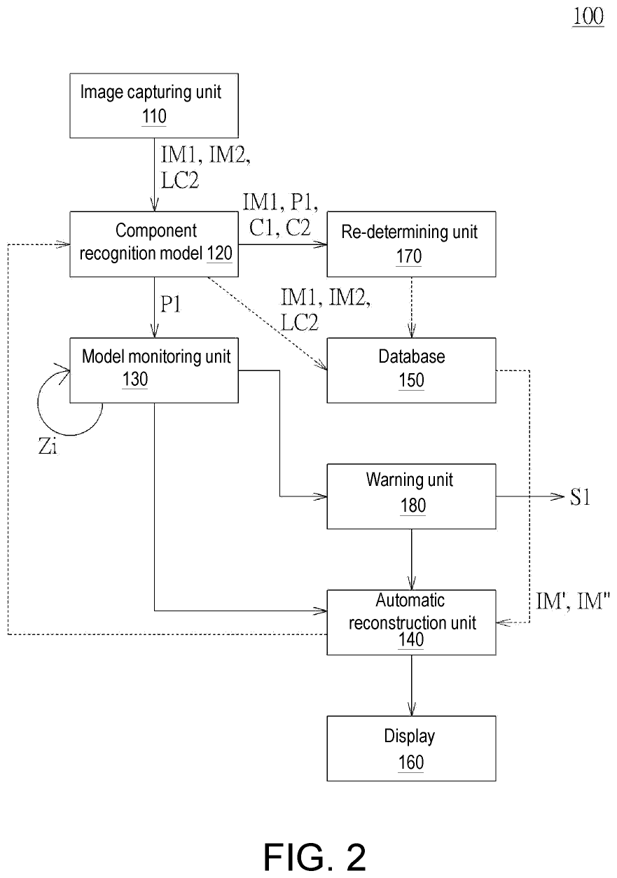

Referring to FIG. 2, FIG. 2 is a block diagram of an automatic model reconstruction system 100 of the component recognition model 120 according to an embodiment. The automatic model reconstruction system 100 includes an image capturing unit 110, the component recognition model 120, a model monitoring unit 130, an automatic reconstruction unit 140, a database 150, a display 160, a re-determining unit 170, and a warning unit 180. The component recognition model 120 is coupled to the image capturing unit 110, the model monitoring unit 130, the automatic reconstruction unit 140, the database 150, and the re-determining unit 170; the model monitoring unit 130 is coupled to the component recognition model 120, the automatic reconstruction unit 140, and the warning unit 180; the automatic reconstruction unit 140 is coupled to the component recognition model 120, the model monitoring unit 130, the database 150, the display 160, and the warning unit 180; and the database 150 is coupled to the component recognition model 120, the automatic reconstruction unit 140, and the re-determining unit 170.

The image capturing unit 110 is, for example, a camera or an optical scanner. The component recognition model 120, the model monitoring unit 130, and/or the automatic reconstruction unit 140 are, for example, program codes, chips, circuits, circuit boards, or storage devices for storing program codes. The database 150 is, for example, a hard disk, a memory, or a cloud storage center. The model monitoring unit 130 monitors the recognition probability value and the position where the component appears, so that the automatic reconstruction unit 140 may automatically obtain training samples and perform the model reconstruction without shutting down the assembly line. The operation of the components is illustrated in detail in a flowchart in the subsequent paragraphs.

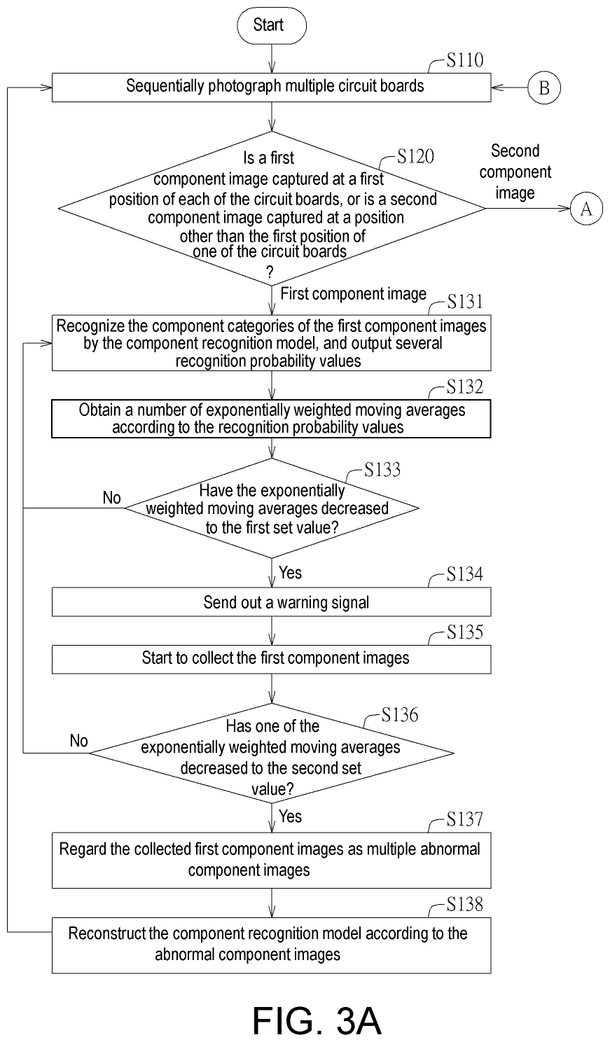

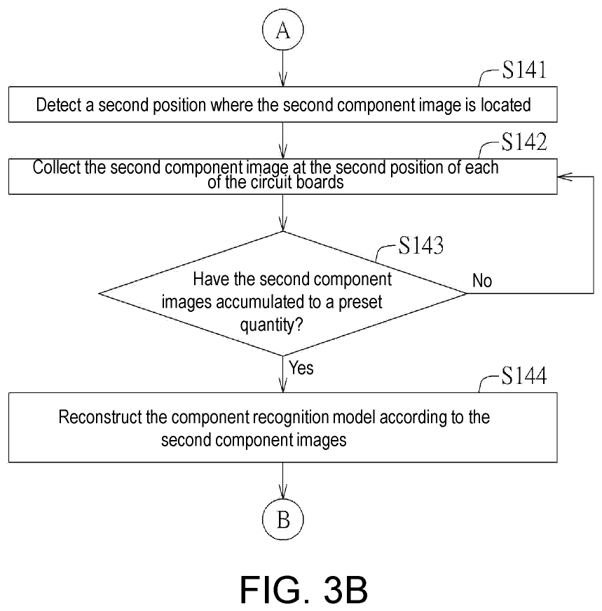

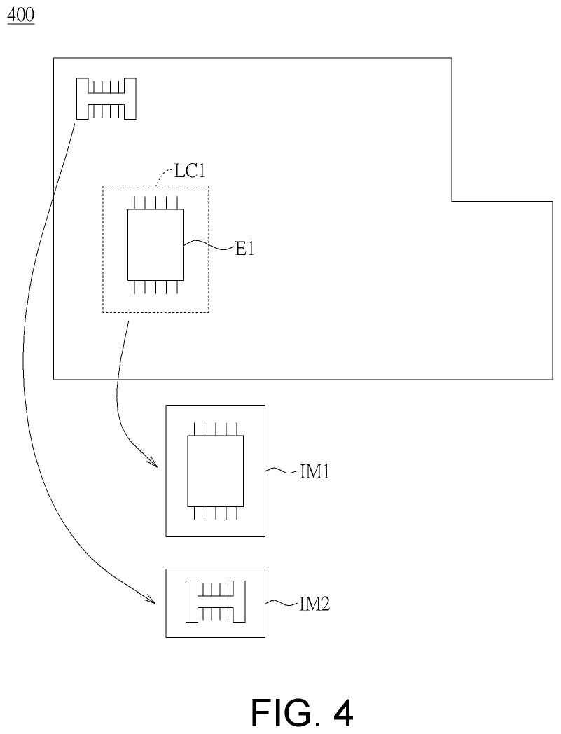

Referring to FIG. 2 to FIG. 4, FIG. 3A to FIG. 3B are flowcharts illustrating an automatic model reconstruction method of the component recognition model 120 according to an embodiment of the disclosure, and FIG. 4 is a schematic view of a circuit board 400 according to an embodiment of the disclosure.

In step S110, the image capturing unit 110 sequentially photographs the multiple circuit boards 400. In the disclosure, “sequentially” means that the image capturing unit 110 may photograph the circuit boards 400 according to the sequence of the circuit boards 400 on the assembly line. This method is to observe whether the production of the circuit boards 400 has changed. In the step, the image capturing unit 110 may detect the component on the circuit board 400 and captures the component image of the component. The component image may be a block image taken individually, or the component image may be cut from an entire circuit board image.

Next, in step S120, it is determined whether a first component image IM1 is captured at a first position LC1 of each of the circuit boards 400, or whether a second component image IM2 is captured at a position other than the first position LC1 of one of the circuit boards 400. As shown in FIG. 4, the component E1 is preset to be disposed at the first position LC1 of the circuit board 400. In the step, the component recognition model 120 determines that whether the image capturing unit 110 captures the first component image IM1 at the first position LC1 or the second component image IM2 at a position other than the first position LC1. In the process of constructing the component recognition model 120, the database 150 has stored the first position LC1, the component category of the first component image IM1, and several historical training samples corresponding to the first component image IM1 of the first position LC1. If the historical training samples can truly reflect all the actual situations on the assembly line, the component recognition model 120 can accurately recognize that the first component image IM1 belongs to a component category C1 (as shown in FIG. 2). If the determined result of step S120 is the first component image IM1 at the first position LC1, then proceed to step S131 to step S138 (as shown in FIG. 3A); if the determined result of step S120 is the second component image IM2 at a position other than the first position LC1, then proceed to step S141 to step S144 (as shown in FIG. 3B). In the subsequent paragraphs, step S131 to step S138 are illustrated first.

In step S131, the component categories of the first component images IM1 are sequentially recognized by the component recognition model 120, and several recognition probability values P1 (as shown in FIG. 2) is output. Each of the recognition probability value P1 is the maximum probability value among various component categories. In the disclosure, the reason for sequentially recognizing the first component images IM1 is to observe whether the first component images IM1 have changed. For example, if ambient light on the assembly line dims at a specific time point, the color of the circuit board 400 may become darker after the specific time point, and the component recognition model 120 may fail to recognize the first component image IM1 captured after the specific time point, such that a lower recognition probability value P1 may output. For each first component image IM1, the component recognition model 120 may output a recognition probability value P1.

Next, in step S132, the model monitoring unit 130 obtains a number of exponentially weighted moving averages Zi (as shown in FIG. 2) according to the recognition probability values P1.

The formula for calculating the exponentially weighted moving average Zi is as follows.

Zᵢ=λ1*xi+(1−λ1)Zᵢ₋₁ (1)

In formula (1), λ1 is a weighted constant with a value between 0 and 1. The value of λ1 may determine the exponentially weighted moving average Zi at the i-th time point depending on the weight of the exponentially weighted moving average Zi−1 at the (i−1)-th time point. xi is the recognition probability value P1 at the i-th time point. The exponentially weighted moving average Zi may reflect the continuous change of the recognition probability value P1.

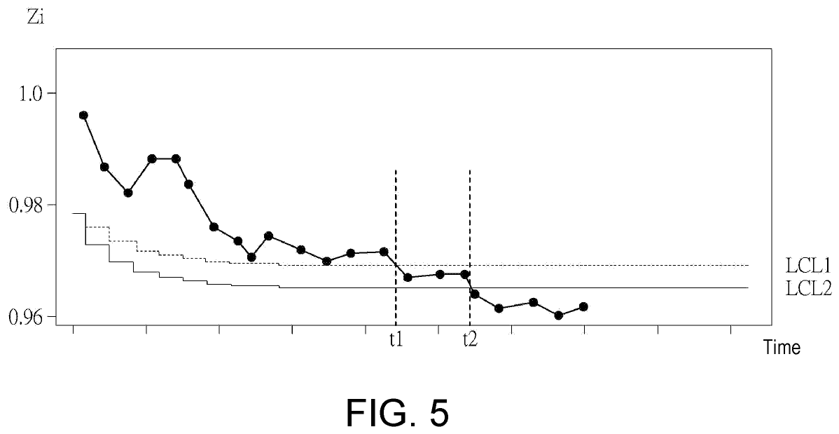

Referring to FIG. 5, FIG. 5 illustrates a distribution of the exponentially weighted moving average Zi according to an embodiment. Since the exponentially weighted moving average Zi at the i-th time point depends on the exponentially weighted moving average Zi−1 at the (i−1) time point, the exponentially weighted moving average Zi may gradually decrease or increase. In the example in FIG. 5, the exponentially weighted moving average Zi gradually decreases.

Next, in step S133 to step S136, from the database 150, the automatic reconstruction unit 140 collects the first component images IM1 corresponding to the exponentially weighted moving average Zi lower than a first set value LCL1 until one of the exponentially weighted moving averages Zi decreases to be lower than or equal to a second set value LCL2.

In step S133, the model monitoring unit 130 sequentially determines whether the exponentially weighted moving average Zi has decreased to the first set value LCL1. As shown at a time point t1 in FIG. 5, the exponentially weighted moving average Zi decreases to the first set value LCL1, indicating that the recognition probability value P1 has approached the preset threshold at this time. In this case, the training data of the component recognition model 120 may no longer reflect the situation on the assembly line.

Next, in step S134, the warning unit 180 sends out a warning signal 51 to remind the staff that the training data of the component recognition model 120 may no longer reflect the situation on the assembly line.

Next, in step S135, the model monitoring unit 130 controls the automatic reconstruction unit 140 to start to collect the first component image IM1. Specifically, after the model monitoring unit 130 determines that the exponentially weighted moving averages Zi have decreased to the first set value LCL1, the model monitoring unit 130 controls the automatic reconstruction unit 140 to start to collect the first component image IM1 from the database 150.

Next, in step S136, the model monitoring unit 130 determines whether one of the exponentially weighted moving averages Zi has decreased to the second set value LCL2, where the second set value LCL2 is less than the first set value LCL1. If yes, proceed to step S137. As shown at a time t2 in FIG. 5, one exponentially weighted moving average Zi has decreased to the second set value LCL2.

In step S137, the model monitoring unit 130 controls the automatic reconstruction unit 140 to regard the collected first component images IM1 as multiple abnormal component images IM1′. Specifically, the collected first component images IM1 are all the first component images IM1 captured after the exponentially weighted moving average Zi is lower than the first set value LCL1.

Formula (2) and formula (3) for calculating the first set value LCL1 and second set value LCL2 are as follows.

$$LCL 1 = {μ}_{0} - L 1 σ \sqrt{( \frac{λ 2}{2 - λ 2} ) [ 1 - {( 1 - λ 2 )}^{2 i} ]} \qquad ( 2 )$$

$$LCL 2 = {μ}_{0} - L 2 σ \sqrt{( \frac{λ 2}{2 - λ 2} ) [ 1 - {( 1 - λ 2 )}^{2 i} ]} \qquad ( 3 )$$

In formula (2) and formula (3), λ2 is a weighting constant with a value between 0 and 1; μ₀ is the average value of the component recognition probability value P1; σ is the standard deviation of the component recognition probability value P1; L1 and L2 are the parameters that determines the upper limit and lower limit of the first sampling rule; and i is the time point.

Next, in step S138, the automatic reconstruction unit 140 reconstructs the component recognition model 120 according to the abnormal component images IM1′. In the step, the automatic reconstruction unit 140 may use all of the abnormal component images IM1′ as training data to perform the model reconstruction. Alternatively, in another embodiment, the automatic reconstruction unit 140 may use a part of the abnormal component images IM1′, such as 80% of the abnormal component image IM1′, as training data for model reconstruction; and the automatic reconstruction unit 140 may use another part of the abnormal component images IM1′, such as 20% of the abnormal component image IM1′, as verification data to verify whether the component recognition model 120 works correctly after the model reconstruction.

After the component recognition model 120 is reconstructed, relevant information may be displayed on the display 160 and provided to the staff for confirming whether to put the updated component recognition model 120 into the assembly line.

Through the step S131 to step S138, when the recognition probability value P1 gradually decreases, the training data may be automatically collected without stopping the assembly line, and the model reconstruction may be automatically executed to update the component recognition model 120. Accordingly, the recognition accuracy of the component recognition model 120 can be improved without suspending the assembly line.

Step S141 to step S144 in FIG. 3 are further illustrated in the subsequent paragraphs. When it is determined in step S120 that the image capturing unit 110 has captured the second component image IM2 at a position other than the first position LC1, proceed to step S141. In step S141, the component recognition model 120 detects a second position LC2 (as shown in FIG. 2) where the second component image IM2 is located. The second position LC2 detected in the step may be recorded in the database 150. Moreover, the component category of the second component image IM2 is also recorded in the database 150 as a training sample for the subsequent process.

Next, in step S142, the model monitoring unit 130 controls the component recognition model 120 to start to collect the second component image IM2 at the second position LC2 of each of the circuit boards 400.

Next, in step S143, the automatic reconstruction unit 140 determines whether the second component image IM2 has accumulated to a preset quantity (e.g., 20 second component images IM2). If yes, proceed to step S144.

In step S144, the automatic reconstruction unit 140 reconstructs the component recognition model 120 according to the collected second component images IM2.

After the component recognition model 120 is reconstructed, relevant information may be displayed on the display 160 and provided to the staff for confirming whether to put the updated component recognition model 120 into the assembly line.

According to step S141 to step S144, when a new component is found, the training data may be automatically collected without stopping the assembly line, and the model reconstruction may be automatically executed to update the component recognition model 120. Accordingly, the recognition accuracy of the component recognition model 120 can be improved without suspending the assembly line.

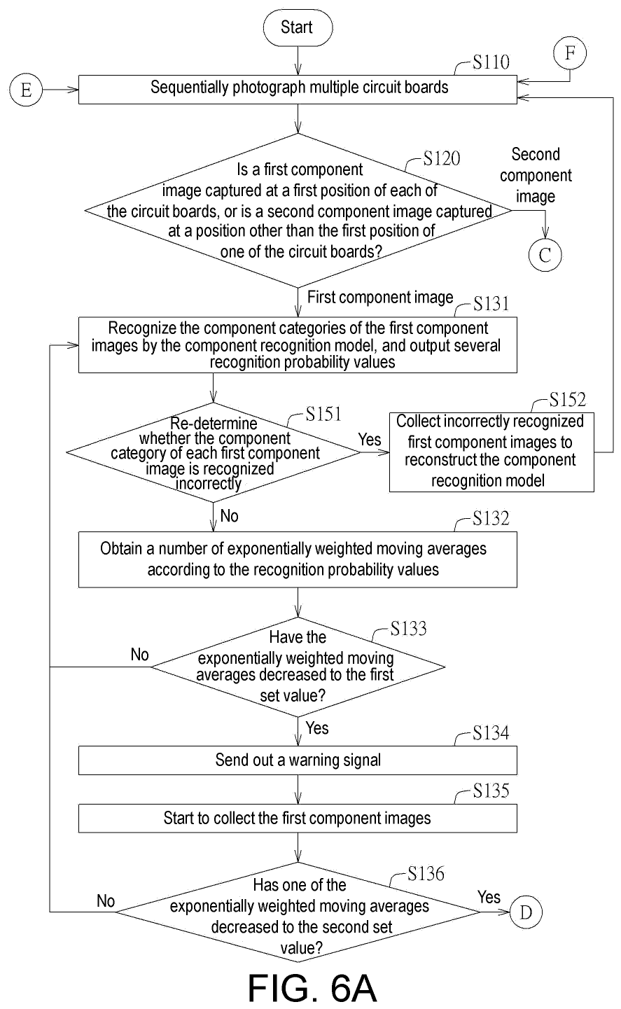

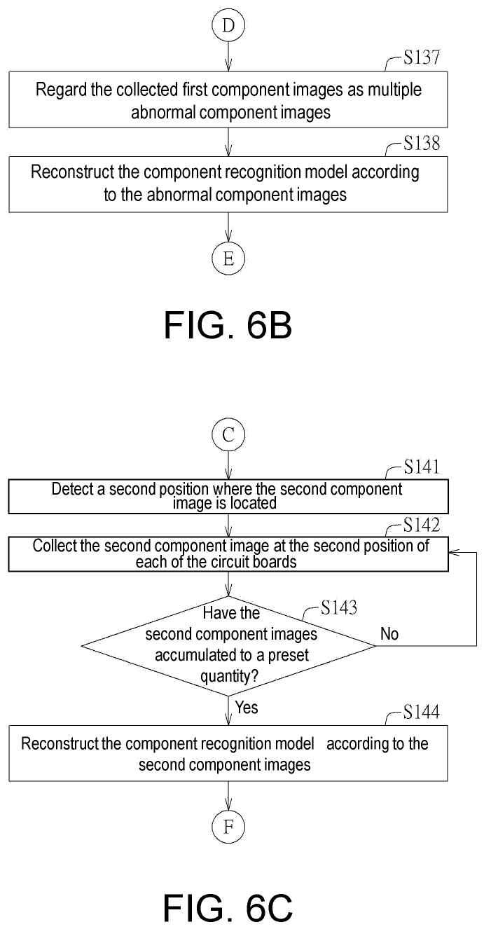

Referring to FIG. 6A to FIG. 6C, FIG. 6A to FIG. 6C are flowcharts illustrating an automatic model reconstruction method of the component recognition model 120 according to another embodiment. In the embodiment of FIG. 6A to FIG. 6C, compared to the embodiment of FIG. 3A to FIG. 3B, the automatic model reconstruction method of the component recognition model 120 further includes re-determining process of step S151 to step S152. In step S151, the re-determining unit 170 re-determines whether the component category of each first component image IM1 is recognized incorrectly. For example, the incorrect recognition includes: (1) The first component image IM1 should belong to the component category C1, but it is recognized as the component category C2 by the component recognition model 120; (2) The first component image IM1 should belong to the component category C1, but it is recognized as not belonging to any preset component category by the component recognition model 120. In some embodiments, the re-determining unit 170 may be implemented manually or by another machine learning model. If the determined result of step S151 is yes, then proceed to step S152.

In step S152, the automatic reconstruction unit 140 collects incorrectly recognized first component images IM1″ for the automatic reconstruction unit 140 to reconstruct the component recognition model 120. Specifically, when determining that the component category of each first component image IM1 is recognized incorrectly, the re-determining unit 170 may correct and mark the first component images IM1″, and sent back to the database 150 to update the database 150. Then, the automatic reconstruction unit 140 may reconstruct the component recognition model 120 according to the updated database.

After the component recognition model 120 is reconstructed, relevant information may be displayed on the display 160 and provided to the staff for confirming whether to put the updated component recognition model 120 into the assembly line.

In summary, although the disclosure has been disclosed in the above embodiments, it is not intended to limit the disclosure. Those with ordinary knowledge in the technical field to which the disclosure belongs can make various changes and modifications without departing from the spirit and scope of the disclosure. Therefore, the protection scope of the disclosure shall be subject to those defined by the attached patent application scope.

What is claimed is:

1. An automatic model reconstruction method for a component recognition model, wherein the automatic model reconstruction method comprises:
sequentially capturing a plurality of first component images of a plurality of circuit boards at a first position;
sequentially recognizing component categories of the first component images by the component recognition model and outputting a plurality of recognition probability values;
obtaining a plurality of exponentially weighted moving averages according to the recognition probability values;
collecting the first component images corresponding to the exponentially weighted moving averages lower than a first set value until one of the exponentially weighted moving averages is lower than or equal to a second set value;
regarding the collected first component images as a plurality of abnormal component images; and
reconstructing the component recognition model according to the abnormal component images.

2. The automatic model reconstruction method according to claim 1, wherein a part of the abnormal component images is used for model reconstruction, and another part of the abnormal component images is used to verify whether the component recognition model works correctly after the model reconstruction.

3. The automatic model reconstruction method according to claim 1, further comprising:
detecting a second position where a second component image is located if the second component image is captured at a position other than the first position of one of the circuit boards;
capturing the second component image at the second position of each of the circuit boards; and
reconstructing the component recognition model according to the second component images when the second component images are accumulated to a preset quantity.

4. The automatic model reconstruction method according to claim 1, wherein after the component recognition model outputs the recognition probability values, the automatic model reconstruction method further comprises:
re-determining whether the component category of each of the first component images is recognized incorrectly; and
collecting incorrectly recognized first component images for constructing the component recognition model.

5. The automatic model reconstruction method according to claim 1, further comprising:
sending out a warning signal when the exponentially weighted moving averages decrease to the first set value.

6. The automatic model reconstruction method according to claim 1, wherein the step of obtaining the exponentially weighted moving averages according to the recognition probability values comprises:
calculating the exponentially weighted moving average at an i-th time point according to the recognition probability value at the i-th time point and the exponentially weighted moving average at an (i−1)-th time point.

7. An automatic model reconstruction system for a component recognition model, comprising:
an image capturing unit configured to sequentially capture a plurality of first component images of a plurality of circuit boards at a first position;
a component recognition model coupled to the image capturing unit, wherein the component recognition model is configured to sequentially recognize component categories of the first component images and output a plurality of recognition probability values;
a model monitoring unit coupled to the component recognition model, wherein the model monitoring unit is configured to obtain a plurality of exponentially weighted moving averages according to the recognition probability values and to determine a relationship between the exponentially weighted moving averages and a first set value and a relationship between the exponentially weighted moving averages and a second set value; and
an automatic reconstruction unit coupled to the component recognition model and the model monitoring unit, wherein the automatic reconstruction unit is configured to collect the first component images corresponding to the exponentially weighted moving averages lower than the first set value until one of the exponentially weighted moving averages is lower than or equal to the second set value, the collected first component images are regarded as a plurality of abnormal component images, and the component recognition model is reconstructed according to the abnormal component images.

8. The automatic model reconstruction system according to claim 7, wherein a part of the abnormal component images is used for model reconstruction, and another part of the abnormal component images is used to verify whether the component recognition model works correctly after the model reconstruction.

9. The automatic model reconstruction system according to claim 7, wherein when a second component image is captured at a position other than the first position of one of the circuit boards, a second position where the second component image is located is detected, the second component images of the circuit boards are captured at the second position, and the automatic reconstruction unit is further used to reconstruct the component recognition model according to the second component images when the second component images are accumulated to a preset quantity.

10. The automatic model reconstruction system according to claim 9, further comprising:
a database coupled to the component recognition model and used to store the first position, the second position, the component categories of the first component images, and the component categories of the second component images.

11. The automatic model reconstruction system according to claim 7, further comprising:
a re-determining unit coupled to the component recognition model and the automatic reconstruction unit and used for re-determining whether the component category of each of the first component images is recognized incorrectly, wherein the automatic reconstruction unit collects the incorrectly recognized first component images for the automatic reconstruction unit to reconstruct the component recognition model.

12. The automatic model reconstruction system according to claim 7, further comprising:
a warning unit coupled to the model monitoring unit and the automatic reconstruction unit and used for sending out a warning signal when the model monitoring unit determines that the exponentially weighted moving averages decrease to the first set value.

13. The automatic model reconstruction system according to claim 7, wherein the model monitoring unit calculates the exponential weighted moving average at an i-th time point based on the recognition probability value at the i-th time point and the exponentially weighted moving average at an (i−1)-th time point.
